(19) United States
(12) Patent Application Publication
(10) Pub. No.: US 2025/0326374 A1
(43) Pub. Date: Oct. 23, 2025

(54) Control System of a Motor Vehicle

(71) Applicant: Bayerische Motoren Werke Aktiengesellschaft, Muenchen (DE)

(72) Inventors: Adem CEYLAN, Muenchen (DE); Alaa MOURAD, Muenchen (DE); Tomas URBAN, Holzkirchen (DE)

(21) Appl. No.: 19/086,259

(22) Filed: Mar. 21, 2025

(30) Foreign Application Priority Data
Apr. 23, 2024 (DE) 10 2024 111 414.2

(51) Int. Cl. B60R 25/24; B60W 30/08; H04W 4/40

(52) U.S. Cl. CPC B60R 25/241; B60W 30/08; H04W 4/40; B60R 2325/205

(57) ABSTRACT

A method for controlling a predetermined safety function of a motor vehicle may comprise steps of detecting a first digital key in a region of the motor vehicle, wherein a first priority is assigned to the first digital key; detecting a second digital key in the region of the motor vehicle, wherein a second priority is assigned to the second digital key and wherein the priorities have different levels; and controlling the safety function on the basis of the key with the higher priority.

### CROSS REFERENCE TO RELATED APPLICATION

This application claims priority under 35 U.S.C. § 119 from German Patent Application No. 10 2024 111 414.2, filed Apr. 23, 2024, the entire disclosure of which is herein expressly incorporated by reference.

### BACKGROUND AND SUMMARY

The present invention relates to the control system of a motor vehicle. In particular, the invention relates to the control system of a motor vehicle by means of a plurality of digital vehicle keys.

A safety function of a motor vehicle, in particular an immobilizer or a central locking system, can be controlled by means of a digital vehicle key. The digital vehicle key and methods for exchanging cryptographic information for controlling a safety function are published in the technical specification “Digital Key Release 3” of the Car Connectivity Consortium.

A dedicated key is usually provided which is assigned to an owner or a person who is similarly responsible for the motor vehicle. Further digital vehicle keys can be generated or digitally signed by means of such an owner key such that they can be forwarded and be used by a different person to control the safety function.

In order to use a digital vehicle key, a wireless connection is produced between a device on which the vehicle key is stored and the motor vehicle or a corresponding control device. If a plurality of vehicle keys are situated in the region of the motor vehicle, they can compete with one another in terms of controlling the safety function. In particular when the safety function is not controlled manually by a user and instead automatically, the behavior of the motor vehicle can be hard to predict or hard to reproduce for a user on board.

An object on which the present invention is based consists in specifying improved technology for controlling a motor vehicle by means of a plurality of digital vehicle keys. The invention achieves this object by means of the subjects of the independent claims. Dependent claims describe related embodiments and implementations.

According to one aspect of the present invention, a method for controlling a predetermined safety function of a motor vehicle comprises steps of detecting a first digital key in the region of the motor vehicle, wherein a first priority is assigned to the first digital key; detecting a second digital key in the region of the motor vehicle, wherein a second priority is assigned to the second digital key and wherein the priorities have different levels; and controlling the safety function on the basis of the key with the higher priority.

By taking account of different priorities, it is possible to prevent two digital vehicle keys from competing with each other in terms of the control of a predetermined safety function. Behavior of the motor vehicle in terms of the control of the safety function can consequently be reproduced more easily or predicted better. A person on board the motor vehicle can be oriented in an improved fashion as to the way in which or why the safety function is controlled.

In contrast to a known distinction between a digital vehicle key of an owner and a digital vehicle key of a friend (owner key vs. friend key), the priorities described herein apply only while the vehicle keys are simultaneously located in the region of the motor vehicle. Priorities which are assigned to the vehicle keys can be chosen independently of whether a vehicle key is assigned to an owner of the motor vehicle or a different person.

A key which does not influence the control of the safety function whilst another key with a higher priority is located in the region of the motor vehicle is preferred. In other words, a key with a lower priority can be passive or neutral in terms of controlling the safety function whilst another, higher-priority key is located in the region of the motor vehicle. The passivity can relate in different embodiments to a safety function which is controlled automatically with regard to the key and/or to a manually controlled safety function.

The technology described herein can in principle be expanded to as many keys as desired and as many priorities as desired. In one embodiment, different priorities are assigned to all the digital vehicle keys for a motor vehicle. The technology described herein can ensure that only precisely one digital vehicle key can be used at any point in time in terms of the controlling of the safety function. If this digital vehicle key is removed from the region of the motor vehicle, the safety function can thus be controlled with the digital vehicle key in the region of the motor vehicle with the highest priority.

A key is preferably linked communicatively to the motor vehicle via a wireless connection. It can be determined that the key is located in the region of the motor vehicle as long as the wireless connection exists.

The wireless connection is preferably implemented by means of a known technology such as Bluetooth (BT) or Bluetooth Low Energy (BLE). Features or options of the radio technology used can thus be exploited.

In one embodiment, a distance between the key and the motor vehicle is determined on the basis of the connection. A key can also be determined as being located in the region of the motor vehicle if this distance falls below a predetermined threshold value. The safety function can moreover be controlled depending on the distance. To do this, a threshold value for the distance can be chosen such that the distance can exceed the threshold value whilst the key is located in the region of the motor vehicle.

In a variant, the safety function is controlled when the determined distance falls below a predetermined threshold value. Thus, a welcome function of the motor vehicle can, for example, be initiated when a digital vehicle key moves closer to the motor vehicle. The welcome function can unlock a door or hatch of the motor vehicle, activate an internal or external light, provide an acoustic signal, start up a system of the motor vehicle or control another function which facilitates use of the motor vehicle by a person who is carrying the key.

In another variant, the safety function is controlled when the determined distance exceeds a predetermined threshold value. In particular, the motor vehicle can be secured against unauthorized use when the key is remote from the motor vehicle. In particular, a door or hatch can be closed or locked. An immobilizer or an alarm system can be activated. A light can be switched off or a system on board the motor vehicle powered down. A function when the key moves further away can generally complement a function when the key moves closer. Other functions can likewise be controlled.

In yet a further embodiment, the higher priority is assigned to the key which is used to control a driving function of the motor vehicle. In particular, the highest priority can be assigned to it among all the keys in the region of the motor vehicle. It can, for example, be determined that the first key is located in the region of a driver's seat on board the motor vehicle before or whilst the motor vehicle drives away. In this case, a priority which is higher than the priority of the second key in the region of the motor vehicle can be assigned to the first key. Correspondingly, a lower priority than the first key can be assigned to the second key.

The driving function can be viewed as the first safety function, wherein a second safety function, different therefrom, can only be controlled on the basis of the key which has triggered the first safety function. It should be noted here that the second safety function can be controlled automatically on the basis of a predetermined event or also manually at the request of a person who is managing the key.

It is possible that a priority is allocated to a key using a digital owner key of the motor vehicle. The owner key is assigned to a predetermined person who can comprise in particular an owner or a person otherwise responsible for the motor vehicle. The owner key can be required for generating or digitally signing a further digital vehicle key. A priority of any desired digital vehicle key can be set or changed using the owner key. This can be the case equally for the owner key and any other key of the motor vehicle.

In particular, the safety function can comprise one of a locking system, an immobilizer, an alarm system, and an autonomous maneuvering function of the motor vehicle. These functions are relevant for the safety or restriction of a function of the motor vehicle to a person authorized to use them. Other such functions can likewise be assisted.

According to a further aspect of the present invention, a device for controlling a predetermined safety function of a motor vehicle comprises a communication apparatus; an interface for controlling the safety function; and a processing apparatus. The processing apparatus is here configured to detect a first digital key in the region of the motor vehicle, wherein a first priority is assigned to the first digital key; to detect a second digital key in the region of the motor vehicle, wherein a second priority is assigned to the second digital key; wherein the priorities have different levels; and to control the safety function on the basis of the key with the higher priority.

The device and in particular the processing apparatus can be configured to partially or completely perform a method described herein. For this purpose, the processing apparatus can be implemented electronically and comprise, for example, an integrated circuit, a programmable logic module, or a programmable microcomputer. The method can be implemented in the form of a configuration or as a computer program product with program code means for the processing apparatus. The configuration or the computer program product can be stored on a computer-readable storage medium. Features or advantages of the method can be transferred to the device, or vice versa.

According to yet a further aspect of the present invention, a motor vehicle comprises a device described herein. The motor vehicle can comprise in particular a car, a motorcycle, a truck, or a bus.

According to a still further aspect of the present invention, a mobile device comprises a secure repository for depositing a digital key for controlling a predetermined safety function of a motor vehicle; and a wireless communication apparatus. The mobile device is here configured to receive a notification about a priority of the key; and to provide an indication of the priority.

The mobile device can comprise in particular a personal device of a user. For example, the mobile device can comprise a smartphone, a smart watch, a smart ring, VR glasses, or a VR headset. In order to use the mobile device and in particular to access the secure repository, it may be necessary for a person to authenticate themselves for the mobile device. The authentication can comprise, for example, demonstrating a biometric feature or inputting predetermined secret information.

The mobile device preferably comprises an output apparatus which is configured in particular optically, acoustically, or haptically. An indication of the priority of the key saved in the secure repository can be provided on the output apparatus. A user of the mobile device can thus identify in an improved fashion whether they can or cannot control the safety function by means of the mobile device.

The mobile device is further preferably additionally configured to receive a notification about a priority of a further digital key in the region of the mobile device; and to provide an indication as to whether the priority of the stored key is higher or lower than that of the further digital key.

For manual control of the safety function, an indication can be issued to a user as to whether the safety function can or cannot be controlled because of the priority of the stored key. In the case of automatic control of the safety function, for example on the basis of a distance between the mobile device and the motor vehicle, an indication can be displayed as to whether the priority of the stored key is sufficient to control or not the function. In one embodiment, the indication can in particular be output when the priority of the stored key is insufficient for controlling the safety function.

The invention will now be described in detail with reference to the attached drawings, in which:

### BRIEF DESCRIPTION OF THE DRAWINGS

FIG. 1 illustrates a system;

FIG. 2 illustrates a flow diagram of a first method;

FIG. 3 illustrates a flow diagram of a second method;

FIG. 4 illustrates a flow diagram of a third method.

### DETAILED DESCRIPTION OF THE DRAWINGS

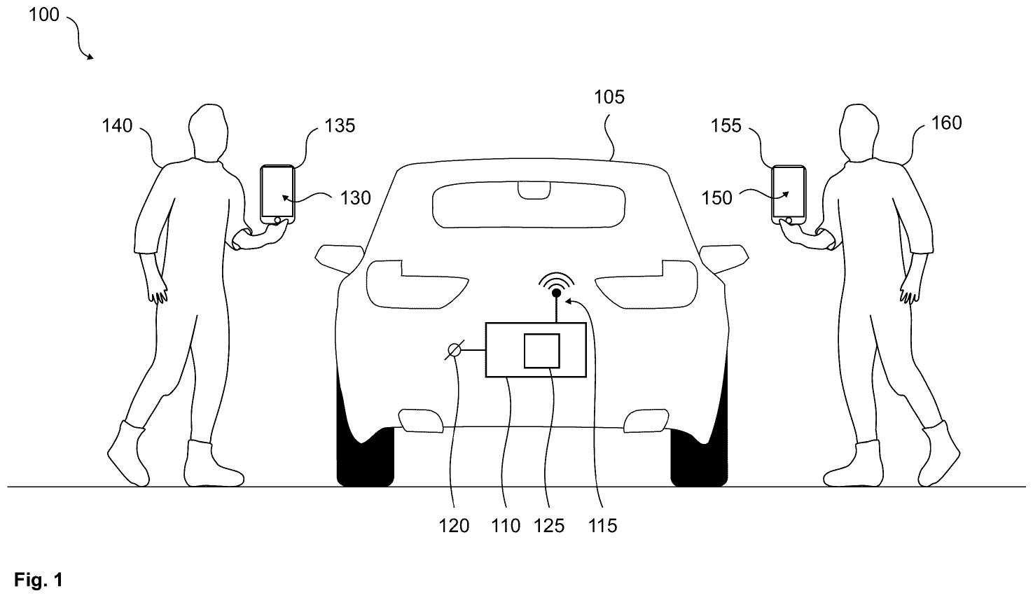

FIG. 1 shows a system 100 with a motor vehicle 105. The motor vehicle 105 comprises a control device 110 which is configured to control a predetermined safety function of the motor vehicle 105. The control device 110 comprises a wireless communication apparatus 115, an interface 120, and a processing apparatus 125. The interface 120 is configured to be connected to a further system, a control device, or an actuator on board the motor vehicle 105, in order to control the safety function. The safety function can comprise in particular unlocking or locking the motor vehicle 105, deactivating or activating an immobilizer or an alarm system.

The safety function is controlled on the basis of a digital vehicle key for the motor vehicle 105. To do this, the digital vehicle key is deposited on a predetermined device, in particular on a mobile device, more preferably a smartphone. A first key 130 which is deposited on a first mobile device 135 which is assigned to a first person 140 is provided in the system 100, as also is a second key 150 which is deposited on a second mobile device 155 which is assigned to a second person 160.

The control device 110 can establish a wireless connection to a mobile device 135, 155 by means of the communication apparatus 115. By means of a predetermined exchange procedure, the devices 110, 135, 155 can be mutually authenticated on the basis of digital keys which are stored in each case. A request to control the predetermined safety function can only be performed if the authentication process has been successful. For further details, reference should be made to the technical specification of the Car Connectivity Consortium “Digital Key Release 3”.

The safety function can be controlled if a person 140, 160 performs a corresponding input on the mobile device 135, 155. The safety function can also be controlled when a predetermined condition is met or a predetermined control event occurs. For example, a relative distance can be determined on the basis of the connection between the communication apparatus 115 and a mobile device 135, 155. If the determined distance exceeds or falls below a predetermined threshold value, this can be interpreted as a control event and an assigned safety function can be controlled.

It is proposed to assign different priorities to the digital keys 130, 150 and, in the case of a plurality of digital keys 130, 150 in the region of the motor vehicle 105, to control a predetermined safety function only with regard to the digital key 130, 150 with the highest priority.

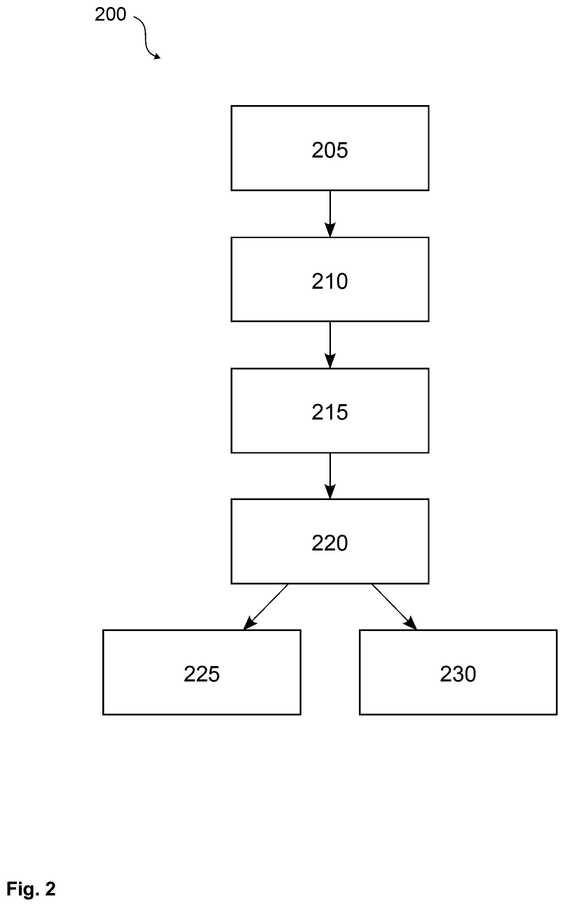

FIG. 2 shows a flow diagram of an exemplary method 200 for controlling a safety function on board the motor vehicle 105. In a step 205, the first key 130 can be detected in the region of the motor vehicle 105. For this purpose, a wireless connection can be established between the communication apparatus 115, the control device 110, and the first mobile device 135 or a communication apparatus comprised by the latter. The connection is preferably established by BT or BLE. Furthermore, the first mobile device 135 is optionally authenticated, for which purpose the first digital vehicle key 130 can be used.

Correspondingly, in a step 210, the second digital vehicle key 150 can be detected in the region of the motor vehicle 105. Here too, a wireless connection can be established between the communication apparatus 115, the control device 110, and the second mobile device 155 or a communication apparatus comprised by the latter.

In an optional step which is not illustrated, further digital vehicle keys 130, 150 can also be detected in the region of the motor vehicle 105. The technology described herein is based on the fact that at least two digital vehicle keys 130, 150 are located in the region of the motor vehicle 105.

In a step 215, a control event can be detected. The control event can comprise a corresponding input of a person 140, 160 at the assigned mobile device 135, 155. The person 140, 160 can request the predetermined safety function, for example by pressing a button or voice input. The request can comprise authentication of the respective mobile device 135, 155 with respect to the control device 110. Authentication of the person 140, 160 with respect to the assigned mobile device 135, 155 can precede this authentication.

The control event can also be determined automatically when a predetermined condition or a predetermined combination of conditions is met. The condition can comprise, for example, a distance between a mobile device 135, 155 and the motor vehicle 105 or the control device 110 exceeding or falling below a predetermined threshold value.

In a step 220, priorities of all the keys 130, 150 in the region of the motor vehicle 105 can be considered. A control event which is based on a key 130, 150 with a priority which is lower than that of another key 130, 150 in the region of the motor vehicle can be rejected. Only when the control event is based on the digital key 130, 150 in the region of the motor vehicle 105 with the highest priority can the control function be controlled.

In a step 225, the predetermined safety function which is assigned to the control event can accordingly be controlled. Alternatively, in a step 230, the control of the safety function can be denied. Optionally, in this case an indication can be provided that execution of the safety function has been denied owing to insufficient priority. The indication is preferably output on board the motor vehicle 105, for example optically on a central display. In addition, an indication about the requested safety function and/or the determined control event can be provided. It can moreover be specified which other digital key 130, 150 in the region of the motor vehicle 105 currently enjoys the highest priority.

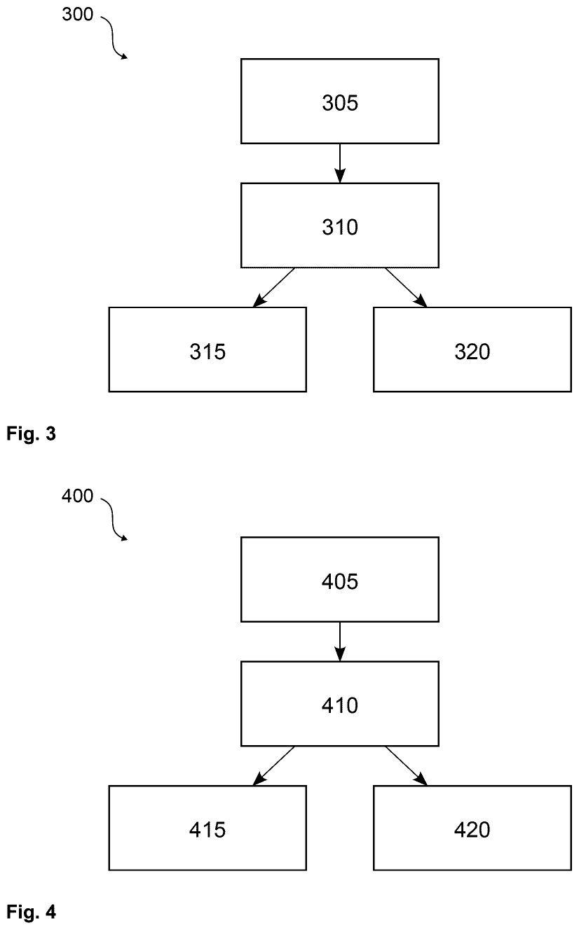

FIG. 3 shows a flow diagram of a second method 300 for controlling a motor vehicle 105. In a first step 305, it is assumed that the first and the second digital keys 130, 150 are present in the region of the motor vehicle 105.

It can be determined in a step 310 that one of the keys 130, 150, in the present case for example the first key 130, is used to control a driving function of the motor vehicle 105. The driving function can comprise in particular starting up the drive motor, engaging a gear, or releasing a parking brake.

Then, in a step 315, the priority of the first key 130 can be raised. Raising the priority can take place in such a way that the priority of the first key 130 is the highest of all the keys 130, 150 in the region of the motor vehicle 105. Correspondingly, in a concurrent step 320, the priority of the second key 150 is lowered. Lowering the priority can take place until the priority of the first key 130 is the highest of all the digital vehicle keys 130, 150 in the region of the motor vehicle 105.

It should be noted that executing just one of the steps 315, 320 can be sufficient to raise the priority of the first key 130 above that of the second key 150. A predetermined safety function can subsequently be controlled only by the first digital vehicle key 130.

The described adaptation of the priorities of the vehicle keys 130, 150 in the steps 315 or 320 can optionally be canceled as soon as the motor vehicle 105 has parked such that the control of the driving function on the basis of the first key 130 is ended.

FIG. 4 shows a flow diagram of a third exemplary method 400 for controlling the motor vehicle 105. The third method 400 is described from the perspective of one of the mobile devices 135, 155.

In a step 405, a priority notification can be received. A priority can be received here which can be assigned to a digital vehicle key 130, 150 stored on the respective mobile device 135, 155. In order to change the priority, authentication can be performed, in particular on the basis of the digital vehicle key 130, 150 stored in each case. Optionally, a priority of a further digital vehicle key 130, 150 in the region of the motor vehicle 105 is also received. Thus, not only the priority of the locally stored digital vehicle key 130, 150 but also the priority of another vehicle key 130, 150 in the region of the motor vehicle can be known at a mobile device 135, 155.

In a step 410, a control event can be detected. The control event can be determined locally at a mobile device 135, 155 or be communicated by the control device 110 in the form of a notification. Before a request to control a safety function assigned to the control event is communicated to the control device 110, the priority of the locally stored digital vehicle key 130, 150 is compared with the priorities of the other digital vehicle keys 130, 150 in the region of the motor vehicle 105.

If the priority of the locally stored vehicle key 130, 150 is the highest of the vehicle keys 130, 150, the assigned safety function can be controlled in a step 415. Otherwise, in a step 420, an indication can be provided that the control of the safety function is impossible owing to insufficient priority. Additional information, in particular with regard to the selected safety function or the determined control event or the priority of another vehicle key 130, 150, can also be provided.

In another embodiment, the priority of the digital vehicle key 130, 150 is not checked in step 410 and instead the request to execute the safety function is communicated directly to the control device 110. If the control device 110 denies the execution of the safety function because of insufficient priority of the locally stored vehicle key 130, 150, a corresponding notification can be communicated to the mobile device 135, 155. The indication in step 420 can in this case also be output.

It should be noted that priorities of the digital vehicle keys 130, 150 in this and possible further embodiments can be deposited outside the mobile devices 135, 155. In particular, the priorities can be stored on board the motor vehicle 105, more preferably in the control device 110. In a further embodiment, a device for storing the priorities which is external to the motor vehicle 105 can also be used. This device can comprise in particular a key server which can execute further functions within the scope of a digital car key.

### LIST OF REFERENCE SIGNS

100 system
105 motor vehicle
110 control device
115 communications apparatus
120 interface
125 processing apparatus
130 first key
135 first mobile device
140 first person
150 second key
155 second mobile device
160 second person
200 first method
205 detection of a first key
210 detection of a second key
215 detection of a control event
220 take priorities into consideration
225 control safety function
230 provide indication of insufficient priority
300 second method
305 first and second key in the region of the motor vehicle
310 first key controls driving function
315 raising of priority of the first key
320 lowering of priority of the second key
400 third method
405 receive indication of priority notification
410 detect control event
415 control safety function
420 provide indication of priorities

What is claimed is:

1. A method for controlling a predetermined safety function of a motor vehicle, the method comprises:
detecting a first digital key in a region of the motor vehicle, wherein a first priority is assigned to the first digital key;
detecting a second digital key in the region of the motor vehicle, wherein a second priority is assigned to the second digital key and wherein the first and second priorities have different levels; and
controlling the safety function on a basis of the digital key with the higher priority.

2. The method according to claim 1, wherein a digital key does not influence the control of the safety function while another digital key with a higher priority is located in the region of the motor vehicle.

3. The method according to claim 1, wherein:
a digital key is linked communicatively to the motor vehicle via a wireless connection; and
it is determined that the digital key is located in the region of the motor vehicle as long as the wireless connection exists.

4. The method according to claim 3, wherein:
a distance between the digital key and the motor vehicle is determined on the basis of the connection; and
the safety function is controlled depending on the distance.

5. The method according to claim 4, wherein the safety function is controlled when the determined distance falls below a predetermined threshold value.

6. The method according to claim 5, wherein the safety function is controlled when the determined distance exceeds a predetermined threshold value.

7. The method according to claim 1, wherein the higher priority is assigned to the digital key which is used to control a driving function of the motor vehicle.

8. The method according to claim 1, wherein the priorities are allocated using a digital owner key of the motor vehicle.

9. The method according to claim 1, wherein the safety function comprises at least one of a locking system, an immobilizer, an alarm system, or an autonomous maneuvering function of the motor vehicle.

10. A device for controlling a predetermined safety function of a motor vehicle, comprising:
a communication apparatus;
an interface for controlling the safety function;
a processing apparatus configured to:
detect a first digital key in a region of the motor vehicle, wherein a first priority is assigned to the first digital key;
detect a second digital key in the region of the motor vehicle, wherein a second priority is assigned to the second digital key and wherein the first and second priorities have different levels; and
control the safety function on the basis of the digital key with the higher priority.

11. A motor vehicle comprising a device according to claim 10.

12. A mobile device comprising:
a secure repository configured to deposit a digital key for controlling a predetermined safety function of a motor vehicle; and
a wireless communication apparatus;
wherein the mobile device is configured to receive a notification about a priority of the digital key and to provide an indication of the priority.

13. The mobile device according to claim 12, wherein the mobile device is configured to:
receive a notification about a priority of a further digital key in the region of the mobile device; and
provide an indication as to whether the priority of the stored digital key is higher or lower.
